(19) United States
(12) Patent Application Publication
(10) Pub. No.: US 2001/0010693 A1
(43) Pub. Date: Aug. 2, 2001

(54) Process for improving the signal quality of optical signals, a transmission system and a transmitter

(76) Inventors: Berthold Wedding, Korntal-Munchingen (DE); Christoph Haslach, Stuttgart (DE)

Correspondence Address: SUGHRUE, MION, ZINN, MACPEAK & SEAS, PLLC, 2100 Pennsylvania Avenue, N.W., Washington, DC, 20037-3213, US

(21) Appl. No.: 09/753,609

(22) Filed: Jan. 4, 2001

(30) Foreign Application Priority Data
Jan. 27, 2000 (DE) 100 03 398.9

(51) Int. Cl. H04B 10/18

(52) U.S. Cl. 370/400; 359/161; 359/181; 359/124; 359/110; 359/170

(57) ABSTRACT

A process for improving the signal quality of optical signals, a transmission system for the transmission of optical signals, and a transmitter for the transmission of optical signals are proposed. Transmission system, transmitter and process operate with a polarization modulator which modulates the optical signal at the transmitter end.

A process for improving the signal quality of optical signals, a transmission system for the transmission of optical signals, and a transmitter for the transmission of optical signals according to the preambles of the independent claims are proposed.

In the optical transmission of high-bit-rate signals with data rates of 10 Gbit/s to 40 Gbit/s, limitations due to the physical properties of the transmission fibres are observed. Problems caused by attenuation and chromatic dispersion are overcome by the use of fibre amplifiers, dispersion-shifted fibres and dispersion compensation techniques. However even when monomode fibres are used, the polarisation mode dispersion (PMD) effect remains as a limiting influence upon fibre length and data rate. PMD has a birefringence effect which primarily causes the signal to be propagated on two different paths and thus leads to a signal distortion. Distortion due to PMD is of a statistical nature and changes over time. In particular, different environmental temperatures result in a fluctuation in the PMD. To obtain analyzable signals in spite of these dispersion effects, many different types of PMD compensation or filtering are used in receivers for optical signals.

For example, the overview article “Equalization of Bit Distortion Induced by Polarization Mode Dispersion” by H. Bülow, NOC 97, Antwerp, p. 65 to 72 describes a number of possibilities whereby polarization mode dispersion can be corrected. One possibility of resolving the problems associated with polarization mode dispersion consists of operating a polarization controller in the receiver and adaptively matching the polarization of the optical signal to the polarization dispersion of the transmission link. The information relating to the polarization dispersion of the transmission link is provided via a back channel. Such polarization control is complex and must be separately implemented for each optical signal of a wavelength. This is particularly problematic when the optical signal is a signal composed of a wavelength division multiplex. Especially in high-bit-rate data transmission systems, the signals are often composed of different wavelength signals. This WDM (wavelength division multiplex) process facilitates the transmission of data which are transmitted on a number of modulated optical carriers with different frequencies. Precisely in such a case, where a plurality of independently operating lasers operate in parallel as sources of the optical signal, active adaptation of the polarization plane of the individual signals is no longer possible.

By way of comparison, the process and transmission system according to the invention have the advantage that no active adaptation of the transmission system to the problems of polarization mode dispersion is performed; rather, the effects of the polarization mode dispersion are statistically distributed by modulation of the polarization plane, such that—averaged over all the optical signals to be transmitted—an improved transmission performance can be obtained. It is advantageous that, with a specific polarization setting of the signal and a specific polarization mode dispersion, the transmission system leads to very high bit error rates and is pulled out of this state by the modulation. On the other hand the system can possess polarization states in which the system operates virtually error-free. The modulation prevents the system from remaining in a very negative transmission state, while at the same time it remains in a positive transmission state only for a limited time. The modulation results in an improved statistical distribution of positive and negative transmission performance due to polarization states of the optical signal viewed over time.

Further developments of measures of the process according to the invention and of the transmission system according to the invention are explained in greater detail in the dependent claims.

The transmission system for a single-channel system advantageously can also be used for a wavelength division multiplex. Only one polarization modulator is likewise required for such a wavelength division multiplex transmission system.

It is additionally advantageous to use a FEC (forward error correction) process in the transmission system. Indeed, the combination of a FEC algorithm with bit error rates of short duration due to the modulation yields particularly advantageous transmission values. The modulation of the polarization state of the optical signal advantageously takes place with a frequency which is smaller than the bit rate, but in the range of the FEC frame frequency. To further improve the transmission system and the process, PMD equalizers should be used in the receiver.

A possible embodiment of the invention is described in the drawings and explained in greater detail in the following description. In the drawings:

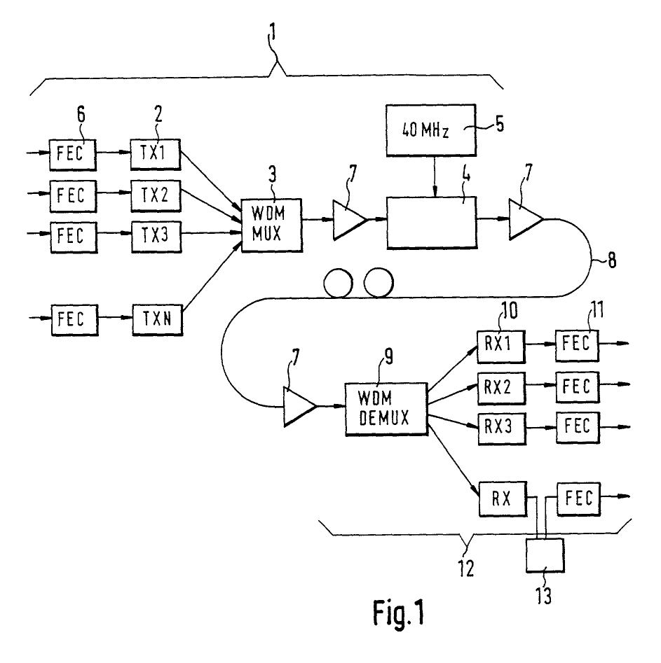

FIG. 1 illustrates a WDM transmission system,

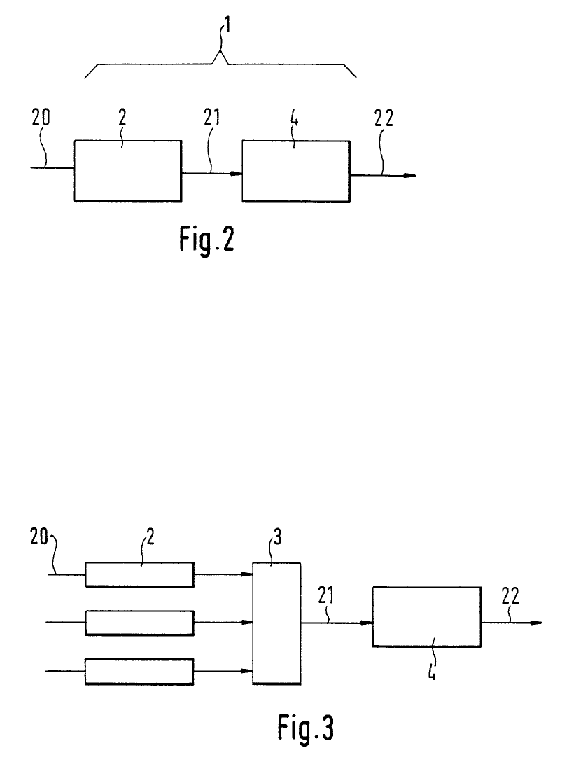

FIG. 2 illustrates an optical transmitter,

FIG. 3 illustrates a transmitter for a wavelength division multiplex,

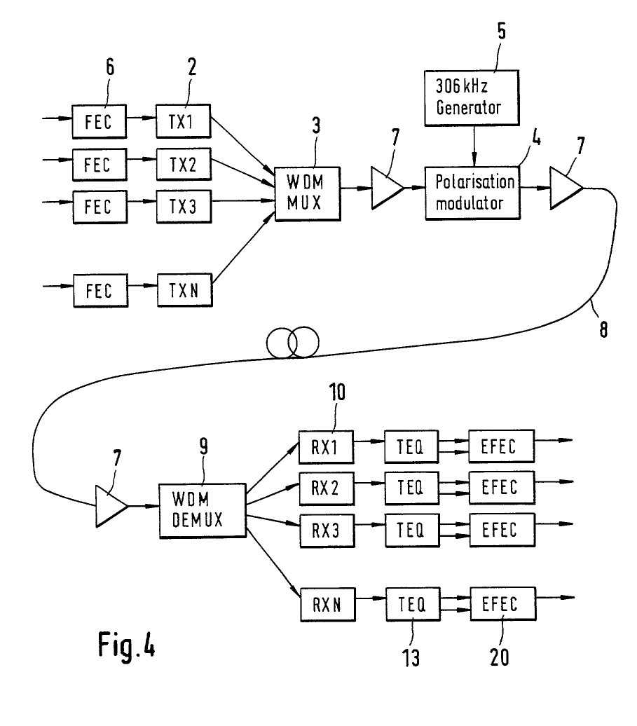

FIG. 4 illustrates a second exemplary embodiment for a WDM transmission system.

FIG. 2 shows the simplest construction of a transmitter according to the invention. The transmitter 1 consists of an electro-optical transducer 2 and a polarization modulator 4. The electric signal 20 occurring at the input end is converted into an optical signal 21 in the electro-optical transducer 2. This optical signal 21 has a specific polarization state. The polarization modulator 4 modulates the polarization state of the optical signal 21 to form an optical output signal 22 with modulated polarization. The modulation generator has not been separately shown in this drawing. The electro-optical transducer consists of a laser diode which is either directly modulated or whose light passes through an external modulator.

A transmitter in the embodiment shown in FIG. 3 serves for use in a wavelength division multiplex. A plurality of electro-optical transducers 2 are used. These electro-optical transducers 2 convert electric input signals 20 into optical signals 21 of different wavelengths. The optical input signals are applied to a wavelength division multiplexer 3. The output signal 23 of the wavelength division multiplexer 3 contains all the information about the different wavelength channels. This signal, which contains different polarization states of the different electro-optical transducers 2, is additionally modulated in the polarization states in the polarization modulator 4. The polarization-modulated optical signal 22 is fed to the transmission link. Specifically for a wavelength division multiplex transmission process of this kind, it is important that the system should not remain in a polarization state for a channel in which high bit error rates are generated. In some cases this leads to a total failure of a wavelength channel. As a result of the modulation this channel is brought into polarization states whose transmission characteristics lead to distinct improvements in the bit error rates.

A further improvement in the process is shown in FIG. 1. FIG. 1 illustrates a complete transmission system for optical signals. A transmitter 1 is connected to a transmission link 8. The transmission link 8 terminates at a receiver 12. The transmitter 1 shown here has additional components compared to the transmitter described with reference to FIG. 3. The electric input signal is firstly applied to a FEC unit 6. The electric input signal passes from the output of the FEC unit 6 to the input of the electro-optical transducer 2. The output of the electro-optical transducer 2 is connected to the input end of the wavelength division multiplexer 3. In this exemplary embodiment the output of the wavelength division multiplexer is connected to an amplifier 7. This in turn is connected to the polarization modulator 4 and to a further amplifier 7. The polarization modulator 4 is connected to a generator 5 for the modulation frequency. The signal of the amplifier 7 passes across the transmission link 8. The signal is applied to the input of a receiver 12. In this case an amplifier 7 again forms the first input stage. The output of the amplifier 7 is connected to a wavelength division demultiplexer 9 whose outputs are each connected to an input of an opto-electric transducer 10. The outputs of the opto-electric transducers 10 are connected to FEC regenerators 11. For the transmission of the optical signals in such a transmission system, the polarization of the optical signal, for example a 10 Gbit/s signal, is modulated with a high frequency. The modulation frequency amounts for example to 40 MHz. A transmission system with polarization mode dispersion can prove particularly susceptible to disturbances under certain conditions. For example, a situation can occur in which the differential group delay time amounts to precisely one bit period and the power in the two orthogonally polarized modes is equal. In such cases even the use of a FEC process cannot ensure good results in the recovery of the signal. Due to the modulation of the polarization, the system is “modulated” out of such a state. The polarization of the optical signal is modulated with a high frequency. This frequency should be of sufficient magnitude to enable the bit errors to be corrected with a FEC process. As a result of the modulation with the high frequency and the averaging of the polarization mode dispersion, bit error rates occur in a short time scale. The resultant bit error rate can then be further reduced by a FEC process. The averaging effect improves the performance of the transmission system compared to an unmodulated system.

Another embodiment uses a PMD equalizer in the receiver 12. This filter is implemented as an electronic filter 13 as described for example in German Application 199 36 254.8. The electronic equalizer 13 has been shown by way of example outside the opto-electric transducer 10. In another embodiment the equalizer is integrated in the opto-electric transducer itself. When an electronic PMD filter is used, it should be ensured that the reaction time of the filter is sufficiently fast to follow the modulation of the polarization.

In another embodiment an optical PMD filter is used in the receiver 12 prior to the opto-electric conversion. Another embodiment employs an optical PMD filter in the receiver 12 before the conversion of the optical signal and an electronic PMD equalizer following the conversion.

FIG. 4 illustrates another improved exemplary embodiment of the WDM transmission system. In this embodiment an error-and-erasure algorithm is used. This known algorithm combined with a high-speed filter 13 enables the length of an error burst to be doubled and improves the PMD tolerance of the optical receiver. An embodiment of the transversal equalizer according to DE 199 936 254.8 is used for example as filter 13. This filter supplies information about the use of the error-and-erasure method derived from the control parameters of the filter 13. The filter must supply information about the location of the error in the signal to support the following stage of the error-and-erasure processing of the signal.

The individual components must be adapted for the design of a transmission system. The form described with reference to FIG. 1 and FIG. 4 represents an exemplary embodiment wherein no specific combination of components need be provided for the application of the principle of the invention.

1. A transmission system for transmitting optical signals via transmission links (8) with transmitters (1) and receivers (12), characterised in that the optical signal (21) passes through a polarization modulator (4) at the transmitter end.

2. A transmission system according to claim 1,
characterised in that the optical signal (21) is composed of signals of a wavelength division multiplex (20).

3. A transmission system according to claim 1,
characterised in that the transmission system comprises components (6, 11) for a FEC (forward error correction).

4. A transmission system according to claim 1,
characterised in that the receiver (12) comprises filters (13) for the compensation of PMD effects.

5. A transmitter for transmitting optical data via glass fibre transmission links with at least one electro/optical transducer and a polarization modulator connected to a generator (5) with a frequency which can be permanently set.

6. A transmitter according to claim 5 with a multiplexer (3) for the multiplexing of optical signals of different wavelengths.

7. A transmitter according to claim 5 with FEC components (6).

8. A process for improving the signal quality of optical signals which are distorted due to polarization mode dispersion, wherein the optical signal is varied in its polarization direction prior to transmission across a transmission link.

9. A process according to claim 8, wherein the optical signal is periodically additionally varied in its polarization direction, the frequency being of sufficient magnitude to enable a FEC process to be used.

10. A receiver (12) for use in a transmission system according to claim 1, wherein the receiver contains demultiplexers (9), optical receivers (12), electronic equalizer (13) and FEC regenerators (11).

11. A receiver according to claim 10, wherein error-and-erasure regenerators are connected to linear equalizers.
